(19) United States
(12) Patent Application Publication
(10) Pub. No.: US 2002/0079730 A1
(43) Pub. Date: Jun. 27, 2002

(54) Fastening device for the fitting part of a fitting fixed to the seat part or seat frame

(76) Inventors: Gerd Schuhmacher, Wuppertal (DE); Heinz Voss, Leverkusen (DE); Helmut Mai, Dusseldorf (DE)

Correspondence Address: FRIEDRICH KUEFFNER, PATENT AND TRADEMARK ATTORNEY, 342 MADISON AVENUE, SUITE 1921, NEW YORK, NY, 10173, US

(21) Appl. No.: 10/040,307

(22) Filed: Jan. 4, 2002

Related U.S. Application Data
(63) Continuation of application No. PCT/EP00/05139, filed on Jun. 6, 2000.

(30) Foreign Application Priority Data
Jul. 5, 1999 (DE) 199 30 945.0

(51) Int. Cl. B60N 2/02

(52) U.S. Cl. 297/378.1

(57) ABSTRACT

A fastening device for a fitting part of a fitting, arranged between a seat part and a back rest, wherein the fitting part is secured on the seat part or a seat frame, has fastening elements configured to pass through at least two openings of the fitting part and to be connected, spaced from one another to the seat part or the seat frame. A first fastening element is a securing bolt having a clamping projection and a second fastening element is a pin configured to engage an insertion opening of the fitting part. The fitting part is plate-shaped.

### CROSS-REFERENCE TO RELATED APPLICATIONS

This application is a continuation of International Application No. PCT/EP00/05139, filed on Jun. 6, 2000.

### BACKGROUND OF THE INVENTION

1. Field of the Invention

The invention relates to a fastening device for the fitting part of a fitting fastened on the seat part or seat frame of a vehicle seat, in particular, motor vehicle seat, which fitting is arranged between the seat part and the back rest, wherein the fastening device has fastening means penetrating at least two openings of the fitting part and connected, spaced apart from one another, to the seat part or the seat frame.

2. Description of the Related Art

From the German patent document DE 28 49 542 A1 a fitting acting as a pivot fitting between the seat part and the back rest is disclosed that connects the seat part with the adjustable and lockable back rest. In this connection, two fitting parts are connected with one another by a simple planetary gear system such that the fitting part connected to the back rest can be pivoted relative to the fitting part connected to the seat part or the seat frame for adjusting and locking the back rest slant. The fitting part correlated with the seat part or the seat frame has in this connection holes at both outwardly positioned ends, respectively, for passing fastening means therethrough so that the fitting part is fixedly connected with the seat part or its seat frame. Such a fastening arrangement of the fitting part on the vehicle seat is selected in particular when the fitting is used for four-door vehicles because the backseat of the vehicle can be accessed via the two rear doors so that the back rest must not be tilted forwardly.

When however in the case of a two-door vehicle a forward folding of the back rest is desired for a more comfortable access to the backseat area, as disclosed, for example, in German patent document DE 43 26 623 A1, the fitting part correlated with the seat part or the seat frame can be supported at its forward end on a pin arranged on the seat part or the seat frame while the rearward portion of the fitting part is supported on a stop which is fixedly attached to the seat and is engaged circumferentially by a catch hook supported on the fitting part.

However, the present invention is concerned with securing the fitting part correlated with the seat part or the seat frame on these components. In this connection, it is known, as mentioned above, to provide two holes in the fitting part for guiding therethrough fastening means wherein these fastening means are generally screws. However, this requires a special configuration of the seat part or the seat frame in which penetrations or holes which are to receive the fastening means, for example, in the form of screws, are to be made; additionally, separate and thus complex assembly steps must be performed.

From DE 198 17 634 C2 a mounting device, in particular, for connecting a seat structure with a vehicle frame, is known which, for the mounting process, can be initially secured simply and quickly on the fastening part by means of a key hole opening and an undercut head bolt wherein subsequently two bores provided in the mounting device serve for fixedly securing the mounting device by means of further fastening means on the fastening part. A disadvantage of this mounting device is that two fastening means are used as securing means for the attachment on the fastening part in addition to the head bolt so that the attachment is made more difficult and requires extra time. Moreover, a play-free attachment of the mounting device is not possible so that the mounting device, when mounting the vehicle seat, must be adjusted on the fastening part. With this additional working step the attachment of the mounting device is additionally made more difficult. Accordingly, the advantages which result from the combination key hole opening and undercut head bolt for attaching the mounting device are cancelled out. Also, the mounting device cannot be used directly for foldable seat backs so that a significantly limited use of such mounting device results.

### SUMMARY OF THE INVENTION

It is an object of the present invention to provide a fastening device which makes possible an identical configuration of the seat part or seat frame with respect to the attachment of the corresponding fitting part without having to take into account whether the back rest is stationary, pivotable and lockable or, moreover, securable in forwardly folded position on the seat part or the seat frame.

In accordance with the present invention, this is achieved in that one fastening means is formed by a securing bolt with a clamping projection while the other fastening means is formed by a pin engaging an insertion opening in the fitting part, and in that the fitting part is plate-shaped.

As a result of the insertion opening, the fitting part can be positioned on the seat part or seat frame having the stationary pin such that the forward opening of the fitting part moves into such a position that the securing bolt, serving as the fastening means and having a clamping projection, can be moved into a prepared threaded bore in the seat part or the seat frame, wherein by means of the clamping projection the fitting part is secured since the pin is also fixed in its locking position in the insertion opening. Even though other fastening means are conceivable, the securing bolt is preferably a head screw having a threaded shaft that can be threaded into a threaded bore or the seat part or the seat frame and having a bolt section with a circular cross-section, wherein the bold section is configured at least over portions thereof as truncated cone.

In order to enable a play-free attachment of the fitting part also on the pin, the pin is a clamping pin and the insertion opening in the fitting part has a funnel-shaped area on whose oppositely positioned flanks the clamping pin will come to rest in the fixation position. As a result of the funnel-shaped area of the insertion opening, on the one hand, the placement and sliding of the fitting part onto the clamping pin, which is embodied, for example, as an upright bold and secured on the seat part or on the seat frame, is made easy and, on the other hand, the slant of the flanks can be selected such that in the fastening position of the fitting part a clamping position is realized between the insertion opening and the clamping pin. It is possible to manufacture all the components of this fastening device of steel wherein, however, it is required to minimize the manufacturing tolerances of these components so that a rattle-free attachment position can be ensured. As is known, a larger tolerance range facilitates manufacture, and, in the present case, is also beneficial when a cylinder section of the clamping pin, engaging the insertion opening in the fastening part, is surrounded by a hard-elastic bushing, This hard-elastic bushing can have a diameter that is minimally greater than the spacing of the flanks to one another at the clamping location of the insertion opening so that in the fixation position of the fitting part a slight deformation of the hard-elastic bushing on its surface can occur which ensures a fixed securing of the insertion opening on the clamping pin.

The clamping deformation of the hard-elastic bushing can also be achieved in that the bushing at its inner circumference has several deformation projections. However, instead of this it is also possible to configure the bushing such that conical rings are provided in the respective end area of its outer circumference which ascend in the outward direction and toward the end faces of the bushing. This has the results that, on the one hand, a clamping deformation of the bushing is obtained and, on the other hand, a centering action of the fitting part with respect to its axial position is achieved.

For achieving an improvement of the clamping position of the clamping pin, it is also possible to taper the insertion opening of the fitting part in the direction toward the opening receiving the screw in the fitting part when the insertion opening emerges from the fitting part so as to point away from the screw.

The funnel-shaped embodiment and thus the tapering of the insertion opening can be eliminated when, as suggested according to a further embodiment of the invention, the clamping pin has an elliptical cross-section whose greatest axis extends in the fasting position of the fitting part transversely to the longitudinal direction of the insertion opening. In this case the insertion opening can be configured such that the fitting part which its placed in an upright position for transfer into its attachment position is pivoted to such an extent that the bore opposite the insertion opening in the fitting part will move into the area of the center of the threaded bore for receiving the screw so that this crew can be threaded while, at the same time, a clamping action of the clamping pin by means of its elliptical circumference with the greatest axis takes place within the insertion opening. In this case it is also possible to adjust the tolerances of the individual components such to one another that a clamping in the fastening position of the fitting part is realized. In order to keep the tolerances within a range facilitating the manufacture, the clamping pin has advantageously a non-round cross-section engaging an elliptical bushing of hard-elastic material for rotationally fixedly securing the elliptical bushing.

### BRIEF DESCRIPTION OF THE DRAWING

In the drawing:

FIG. 1 shows a fitting which is arranged between the seat part and back rest of a vehicle seat whose fitting part correlated with the seat part comprises one of the aforementioned fastening devices;

FIG. 2 shows a fitting part, correlated with the seat part and positioned in the fastening position, into whose forward opening a head screw is inserted while the rear ward opening is configured as a key hole-shaped insertion opening having a funnel-shaped area for fixation on a clamping pin;

FIG. 3 shows a fitting part illustrated in FIG. 2 during the placement phase of its insertion opening onto the clamping pin having a head disk;

FIG. 4 shows the fitting part illustrated in FIGS. 2 and 3 in a transition phase shortly before reaching the clamping position on the clamping pin;

FIG.5 shows the fitting part illustrated in FIGS. 2-4 after reaching its clamping position on the clamping pin and after threading the screw into the forward opening of the fitting part;

FIG. 6 shows a further embodiment of a fitting part with an insertion opening which is open to the rear in an approximately vertical placement position on the clamping pin;

FIG.7 shows the fitting part illustrated in FIG. 6 in a position transferred into a substantially horizontal forward pivoting position about the clamping pin at the beginning of threading of the screw into the forward opening of the fitting part;

FIG. 8 shows the fitting part illustrated in FIGS. 6 and 7 in a clamping position which is secured by tightening the screw in the forward opening;

FIG. 9 shows a further embodiment of a fastening device for a fitting part whose insertion opening for the clamping pin is angularly shaped and extends approximately in the horizontal direction and to the rear and emerges at the underside of the fitting part from it, wherein the fitting part is illustrated in a phase of placement onto the clamping pin;

FIG. 10 shows the fitting part illustrated in FIG. 9 shortly before the clamping end position on the clamping pin is reached, wherein however the forward opening already allows the introduction of the screw into a threaded portion on the seat frame;

FIG. 11 shows the fastening position of the fitting part illustrated in FIGS. 9 and 10 in which its clamping position is secured by the screw threaded into the seat frame;

FIG. 12 shows an embodiment of a screw securing the forward opening of the fitting part on the seat frame formed by a guide rail in a broken-away sectional illustration according to the line XII-XII of FIG. 1 on an enlarged scale relative to FIG. 1;

FIG. 13 shows the clamping pin inserted into the insertion opening whose support shaft is surrounded by a hard-elastic bushing;

FIG. 13A shows the clamping pin arranged in the insertion opening of the fitting part in a sectional view according to line XIIIA-XIIIA of FIG. 13;

FIG. 14 shows a further embodiment of a bushing surrounding the support shaft of the clamping pin in a representation analog to FIG. 13;

FIG. 14A shows the support shaft of the clamping pin enclosed by a hard-elastic bushing inserted into the insertion opening in a sectional view in analogy to FIG. 13A;

FIG. 15 shows a further embodiment of a hard-elastic bushing surrounding the support shaft of the clamping pin which has a greater inner diameter relative to the support shaft;

FIG. 15A shows the embodiment of a hard-elastic bushing surrounding the clamping pin illustrated in FIG. 15 in a sectional view analog to FIG. 13A and FIG. 14A;

FIG. 16 shows a further embodiment of a hard-elastic bushing surrounding the support shaft of the clamping pin which by means of conical projections at the edge provides an axial guiding of the fitting part engaging the bushing by means of the insertion opening, wherein this illustration of FIG. 16 is analog to the illustrations of FIGS. 13, 14, and 15;

FIG. 16A shows the embodiment illustrated in FIG. 16 in a sectional illustration analog to FIG. 13A;

FIG. 17 shows the elliptically embodied support shaft of the clamping pin in a sectional view corresponding to FIGS. 13A-16A, wherein the insertion opening of the fitting part is placed thereon in the vertical direction;

FIG. 17A shows an intermediate position of the fitting part being in its pivot phase wherein the lateral flanges of the insertion opening rest against oppositely positioned sides on the support shaft of the clamping pin;

FIG. 17B shows the final pivot position of the fitting part, wherein the elliptical cross-section is clamped by the support shaft of the clamping pin at the highest points of its periphery on oppositely positioned flanks of the insertion opening.

### DESCRIPTION OF THE PREFERRED EMBODIMENTS

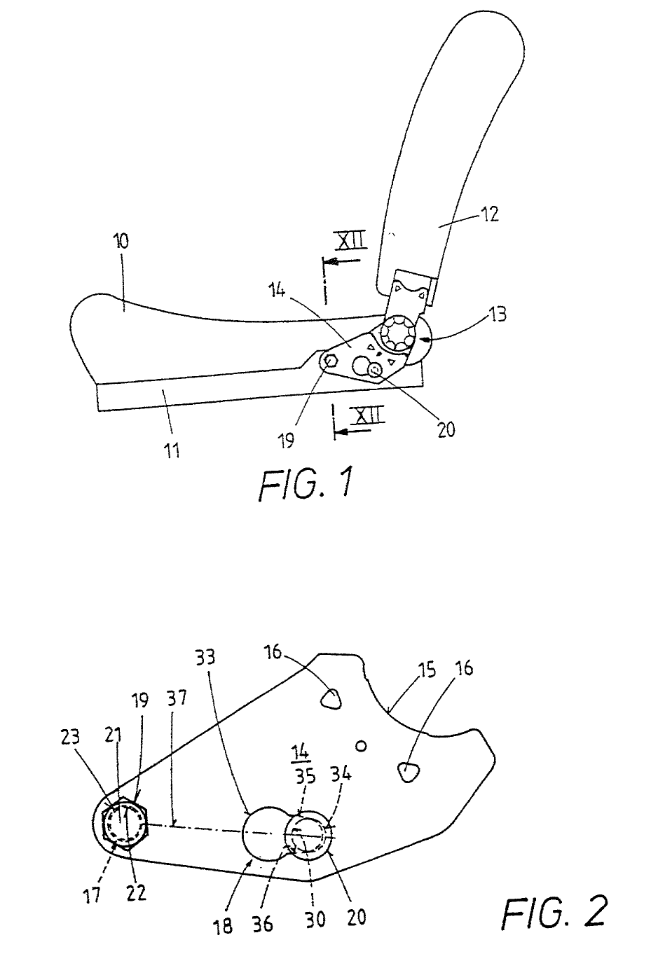

Even though the fitting illustrated in FIG. 1 is a joint fitting for adjustment of the back rest slant, it is also possible to arrange a stationary fitting between the seat part and the back rests whose fitting part secured on the seat part or on the seat frame can be secured in the same way on the seat part or the seat frame as described in the following.

The vehicle seat illustrated in FIG. 1 comprises a seat part 10 with a correlated seat frame 11 and a back rest 12 which is adjustable and lockable in its slanted position on the seat part 10 by, for example, a joint fitting 13. While the pivotable fitting part is fixedly connected with the back rest 12, the stationary fitting part 14 is fixedly connected, for example, by means of the seat frame 11 on the seat part 10.

In the embodiment of the fitting part 14 illustrated in FIG. 2, it has a circular arc-shaped cutout 15 in an upper laterally displaced area and at a spacing thereto concentrically arranged welded projections 16 are provided on the fitting part in order to connect it with brackets of an adjusting and locking device, not illustrated but known in general in the art. In the lower area the fitting part 14 has openings 17 and 18 arranged at a spacing to one another which penetrate the plate-shaped fitting part 14. These openings 17 and 18 serve for receiving fastening means 19 and 20 which, in turn, are connected fixedly or can be connected fixedly to the seat frame 11 of the seat part 10.

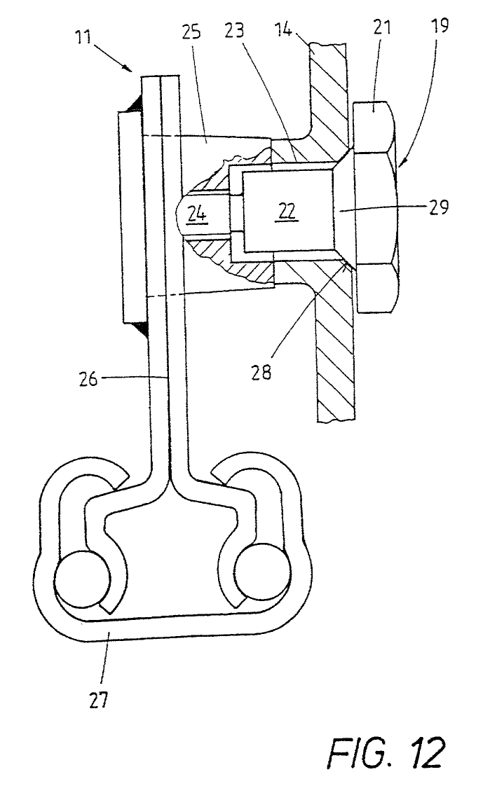

The fastening means 19 is, as illustrated in FIGS. 2 and 12, a head screw 21 whose bold section 22 in regard to its diameter is somewhat smaller than the bore 23 in the fitting part 14 providing the opening 17. Adjacent to the bolt section 22 of the head screw 21, a threaded shaft 24 is positioned which, for example, can be screwed into a fastening eye 25 which, in turn, is secured, for example, on a running rail 26 belonging to the seat frame 11. In the case of using a running rail 26, the rail 26 engages a guide rail 27, as is known in the art, which, in turn, can be secured on the vehicle floor. In this way, the seat part 10 is longitudinally movable relative to the vehicle floor (FIG. 12). The circular bolt section 22 has in the area of its transition into the head of the head screw 21 a clamping projection 28 which in the illustrated embodiment of FIG. 12 is a truncated cone 29. By means of this clamping projection 28 a centered fixation of the fitting part 14 on the seat frame 11 is possible.

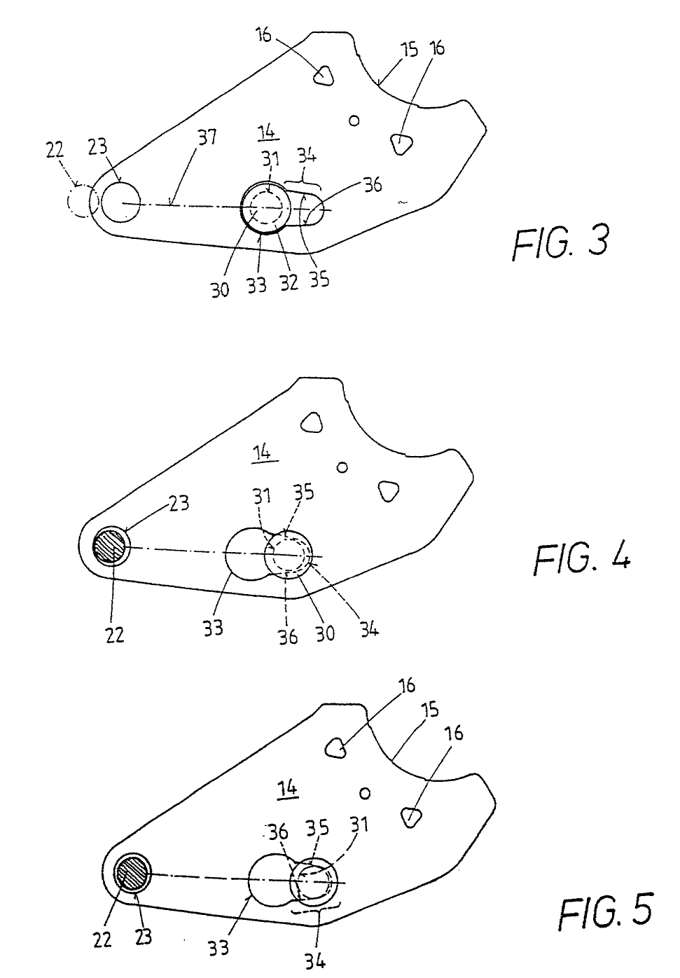

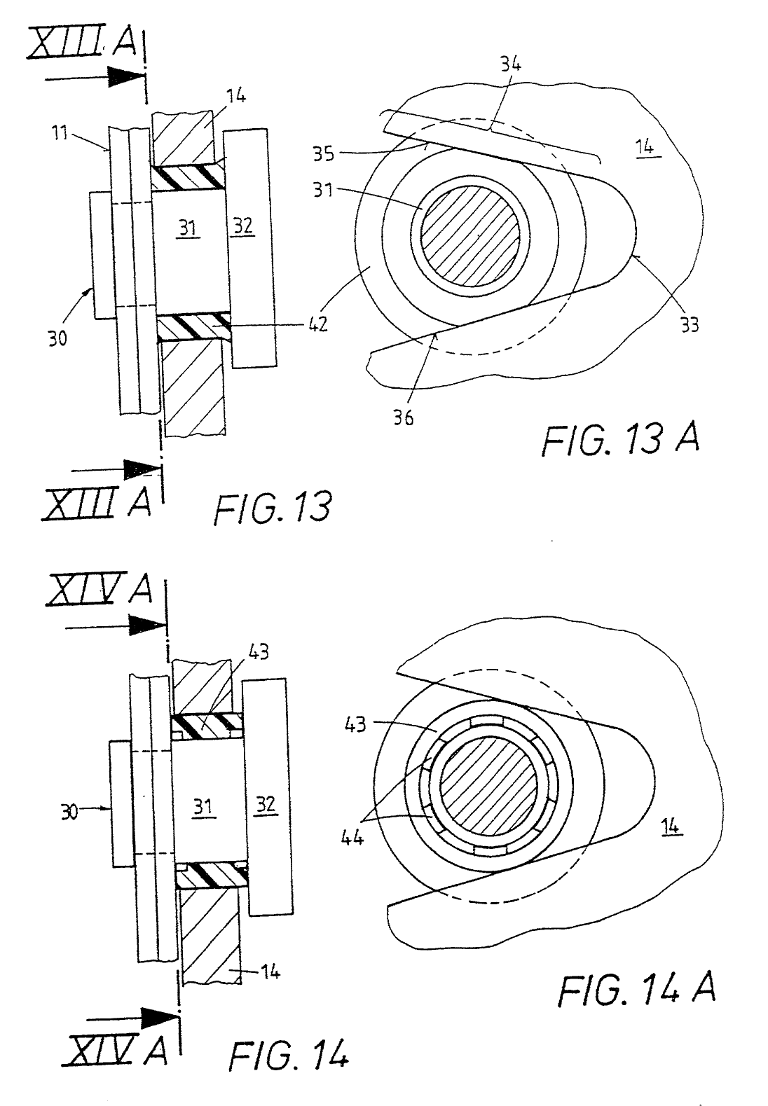

The other fastening means 20 is comprised of a clamping pin 30, as illustrated in the embodiments of FIGS. 13-17B, secured on the seat frame 11 or on the running rail 26 correlated with the seat frame 11. This clamping pin 30, which is, for example, riveted onto the seat frame 11, has a support shaft which is formed as a cylinder section 31 in the embodiments according to FIGS. 13-16. A head disk 32 adjoins as a unitary part the cylinder section 31 and engages portions of the fitting part 14 and axially secures it. The cylinder section 31 of the clamping pin 40 penetrates an insertion opening 33 which is provided within the fitting part 14 and has a key hole shape in the embodiment illustrated in FIGS. 2-5. This insertion opening 33 has funnel-shaped area 34, respectively, whose oppositely positioned flanks 35 and 36 extend at a slant relative to the longitudinal axis 27 of the insertion opening 33. The extension of the longitudinal axis 37 of the insertion opening 34 extends also through the center of the bore 23. In this connection, the slant of the flanks 35 and 36 relative to the longitudinal axis 37 and to one another is selected such that, upon moving the fitting part 14 in the direction of the locking position illustrated in FIGS. 2 and 5, the flanks 35 and 36 will approach one another and finally tangentially contact the clamping pin 30. As can be seen in particular in FIG. 3, the area adjoining the funnel-shaped area 34 of the insertion opening 33 is formed such that it can be slipped over the head disk 32 of the clamping pin 30. In this position illustrated in FIG. 3 the center of the bore 23 of the fitting part 14 is positioned remote from the center of the fastening eye 25 whose center coincides with the longitudinal center of the head screw 21, that can be threaded into the threaded bore of the fastening eye 25, and thus also with its bolt section 22. Upon slipping the fitting part 14 over the cylinder section 31 of the clamping pin 30 in the direction toward the center of the fastening eye 25, the position illustrated in FIG. 4 is finally reached in which the flanks 35 and 36 of the funnel-shaped area 34 of the insertion opening 33 have not yet completely contacted the cylinder section 31 of the clamping pin 30 and the bore 23 moreover has a substantially eccentric position relative to the center of the fastening eye 25. However, it is already possible to insert through the bore 23 the head screw 21 with its bolt section 22 so that, upon screwing of the threaded shaft 24 of the head screw 21 into the inner thread of the fastening eye 25, the position illustrated in FIG. 5 is reached by means of the clamping projection 28 of the head screw 21. In this position, as a result of the central contact of the truncated cone 29 in the bore 23, the fitting part 14 has been pulled so far over the cylinder section 31 of the clamping pin 30 that the flanges 35 and 36 of the funnel-shaped area 34 of the insertion opening 33 rests securely on the cylinder section 31 of the clamping pin 30. In this connection, the fitting part 14 illustrated in the embodiment of FIGS. 2-5 is fixedly connected with the seat frame 11 of the seat part 10.

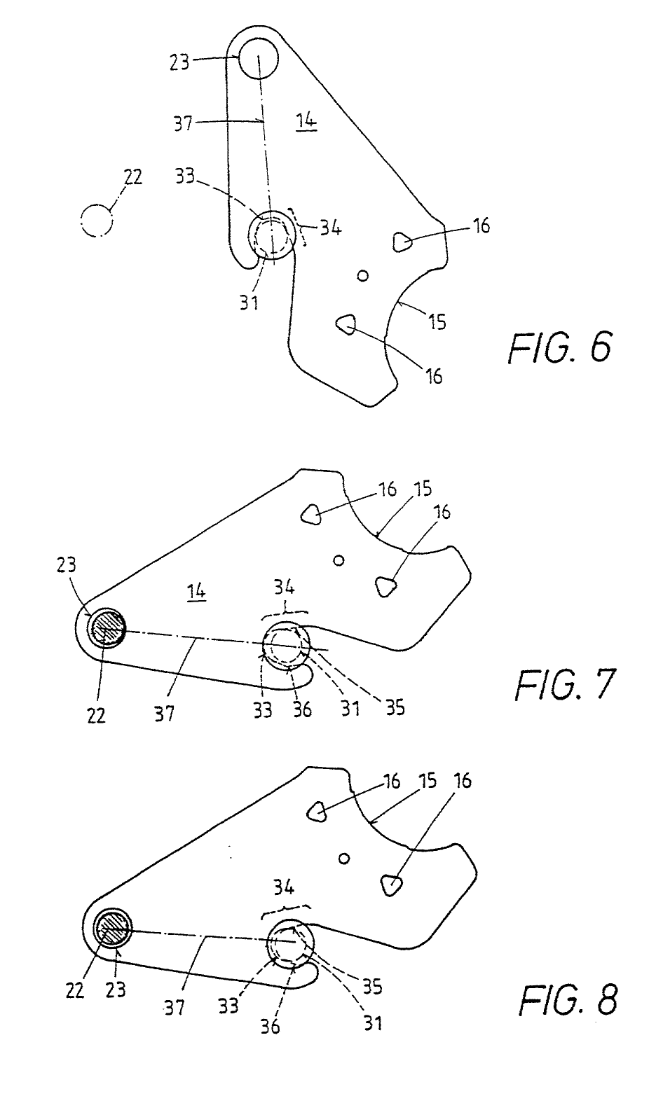

In FIGS. 6 to 8 a modified embodiment is illustrated in which the head screw 21 with its bolt section 22 as well as the clamping pin 30 with its cylinder section 31 as well as the bore 23 in the fitting part 14 are configured in the same way as in the embodiment corresponding to FIGS. 2-5. The difference in this second embodiment is the insertion opening 33 which also has a funnel-shaped area 34 which opens however to the backside of the fitting part away from the bore 23. For securing the fitting part 14 of this embodiment on the seat frame 11, at the beginning of assembly this fitting part 14 is placed in the position illustrated in FIG. 6 onto the cylinder section 31 of the clamping pin 30 and subsequently is pivoted forwardly into the position illustrated in FIG. 7. When doing so, the bore 23 is moved into such a position that its center is eccentric to the center of the fastening eye 25 so that a forwardly pointing sickle-shaped gap at the beginning of threading of the head screw 21 is provided between the bolt section 22 and the bore 23 whose greatest play is in the longitudinal axis 37 before the bolt section 22. In this situation there is also minimal play between the cylinder section 31 of the clamping pin 30 and the flank 36 of the funnel-shaped area 34 of the insertion opening 33. Toward the end of the threading process of the head screw 21, its truncated cone 29 will come to rest against the bore 23 so that the fitting part 14 is moved to the rear and the cylinder section 31 of the clamping pin 30 is pressed against the flanks 35 and 36 of the funnel-shaped area 34 of the insertion opening 33. This situation is illustrated in FIG. 8.

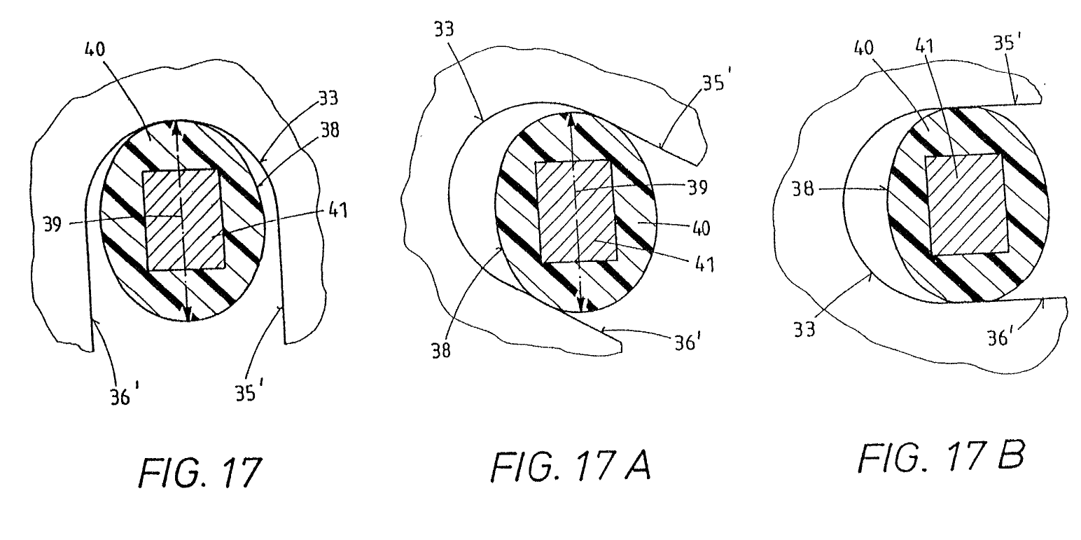

This aforementioned modification, illustrated in the FIGS. 6-8, can be further modified in that the insertion opening 33 has no longer a funnel-shaped area but instead has parallel-extending flanks 35′ and 36′ of a slotted hole open toward the backside. The clamping pin engaging this insertion opening 33 then has a clamping pin section 38 whose outer contour is that of an elliptical section whose greatest axis 39, when the fastening part 14 is in the fastening position, extends transversely to the longitudinal direction of the insertion opening 33. For securing the fastening position despite unavoidable tolerances, the clamping pin section 38 has an elliptical bushing 40 of, for example, hard-elastic material, which is placed onto a non-round cross section 41 of the clamping pin 30. In this way, in any situation a fastening position analog to FIG. 8 can be achieved because the elliptical bushing 40 in the clamping situation can be deformed for contacting the flanges 35 and 36, as illustrated in FIG. 17B.

For the same aforementioned reason the cylinder section 31 of the clamping pin 30 can also be surrounded by a hard-elastic cylindrical bushing 42. The outer diameter of this bushing can then be of a slightly greater diameter than the spacing between the flanks 35 and 36 of the funnel-shaped area 34 of the insertion opening 33 upon reaching the final fastening position (FIG. 13A). However, the embodiment of the bushing 42 is not limited to the shape illustrated in FIG. 13 and 13A but can also be configured differently, for example, as disclosed in FIGS. 14 and 14A. This bushing 43 has at its inner circumference deformation projections 44 which can be embodied, for example, in the form of ribs extending in the longitudinal direction of the bushing 43.

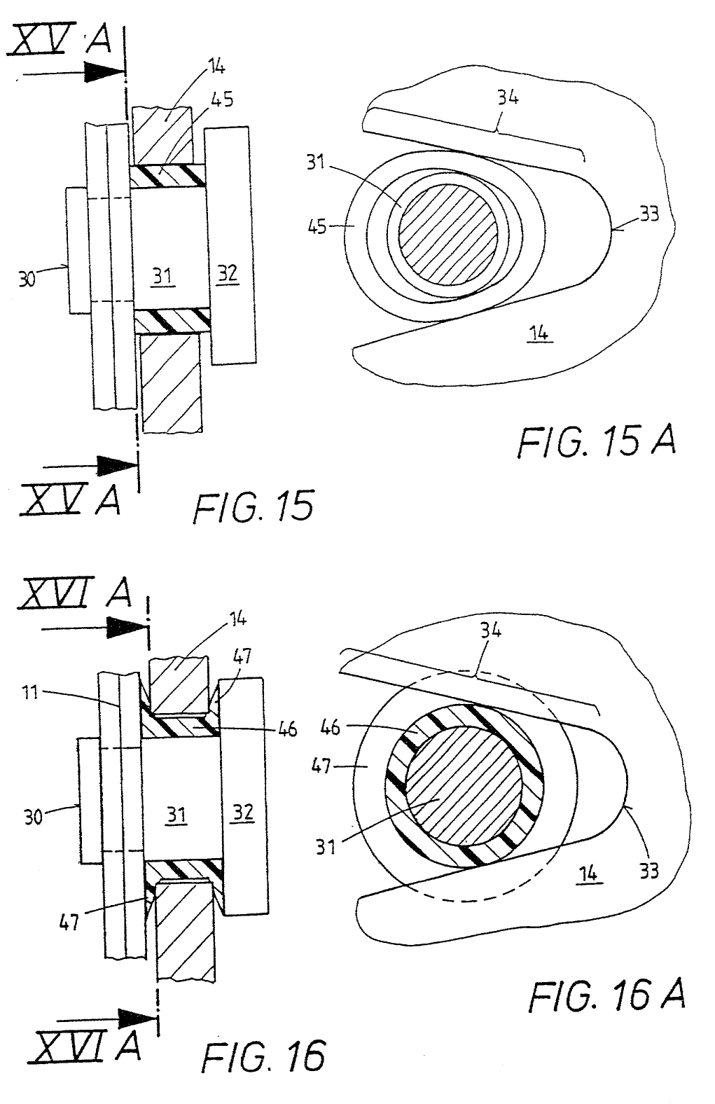

Moreover, it is conceivable to arrange on the cylinder section 31 a cylindrical bushing 45 of hard-elastic material whose inner diameter is slightly greater than the outer diameter of the cylinder section 31 so that a deformation of the busing 45 is realized in the fastening position, as can be seen in FIG. 15A.

A further embodiment of a bushing 46 surrounding the cylinder section 31 of the clamping pin 30 is illustrated in FIG. 16 and 16A. This bushing 46 which is substantially cylindrical and ring shaped has at its outer circumference in the area of its two end faces con rings 47 which, starting at the outer circumferential area, ascent outwardly toward the end faces and are unitary components of the bushing 46. This bushing 46 is also preferably made of a hard-elastic plastic material. However, other elastic materials can also be used and in some cases it is also possible to employ spring steel for some of the afore described bushings 40, 41, 42, 43, 45, and 46.

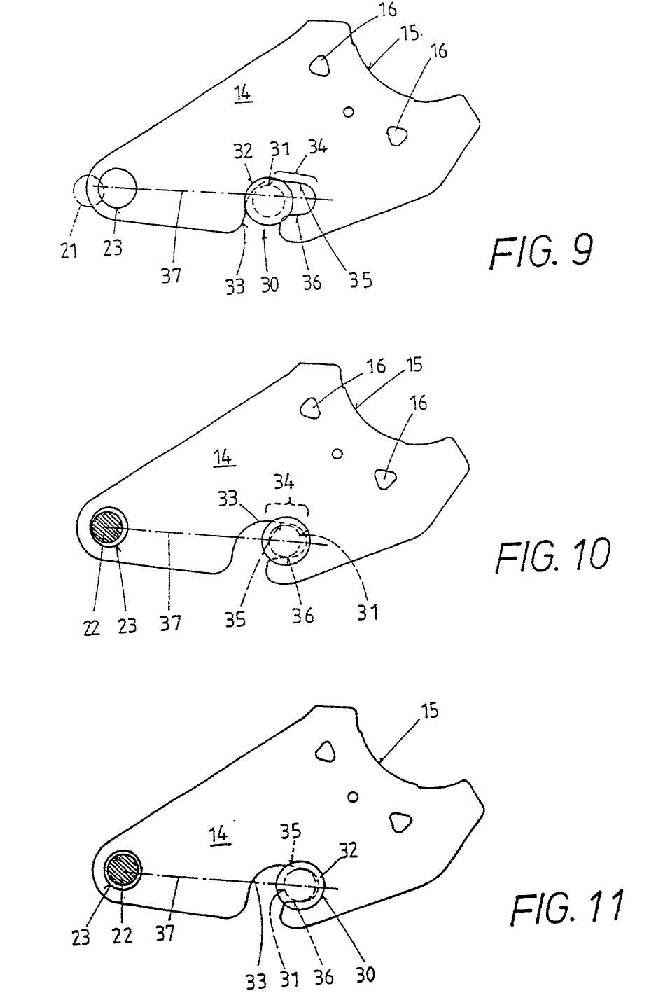

The third version of the fastening device for the fitting part 14 can be seen in FIGS. 9 to 11. In this version in the forward area of the fitting part 14 a bore 23 is arranged through which a head screw 21 can be pushed which, in turn, can be threaded with its threaded shaft 24 into a threaded bore of the fastening eye 25 of the seat frame 11 wherein its bolt section 22 can engage with play the bore 23. In this version, the head screw 21 has also a clamping projection 28 in the form of a truncated cone 29. In the rearward area, at the underside of the fitting part 14, there is also an insertion opening 33 which is, however, of an angular configuration and is open toward the underside of the fitting part 14. The area of the insertion opening extending in the longitudinal direction of the longitudinal axis 37 connecting the bore 23 and the insertion opening 33 is also formed as a funnel-shaped area 34 and has therefore oppositely positioned, slanted flanks 35 and 36 which taper in the direction of the sides facing away from the bore 23. Based on the first mounting step illustrated in FIG. 9, the fitting part 14 can be placed behind the head disk of the clamping pin 30 onto its cylinder section 31 and can be moved forwardly into the position illustrated in FIG. 10. In this connection, between the flanks 35 and 36 of the insertion opening 33 and the cylinder section 31 as well as between the bolt section 22 of the head screw 21 to be threaded and the bore 23 play is present which is eliminated only toward the end of the screwing process of the head screw 21 as a result of the clamping projection 28 on the head screw 21 so that the fastening position of the fitting part 14 illustrated in FIG. 11 is reached.

While specific embodiments of the invention have been shown and described in detail to illustrate the inventive principles, it will be understood that the invention may be embodied otherwise without departing from such principles.

What is claimed is:

1. A fastening device for a fitting part of a fitting, arranged between a seat part and a back rest, wherein the fitting part is secured on the seat part or a seat frame, the fastening device comprising:
fastening means configured to pass through at least tow openings of the fitting part and configured to be connected, spaced apart from one another, to the seat part or the seat frame;
wherein a first one of the fastening means is a securing bolt having a clamping projection and wherein a second one of the fastening means is a pin configured to engage an insertion opening of the fitting part, wherein the fitting part is plate-shaped.

2. The fastening device according to claim 1, wherein the securing bolt is a head screw having a threaded shaft configured to be threaded into a threaded bore of the seat part or the seat frame and having a bolt section with a circular cross-section, wherein at least a portion of the bolt section has a truncated cone shape.

3. The fastening device according to claim 3, wherein the insertion opening of the fitting part has a funnel-shaped area having opposed flanks, wherein the pin is a clamping pin configured to engage the opposed flanks.

4. The fastening device according to claim 3, further comprising a hard-elastic bushing, wherein the clamping pin has a cylinder section configured to engage the insertion opening in the fitting part, and wherein the bushing is placed onto the cylinder section and surrounds the cylinder section.

5. The fastening device according to claim 4, wherein the bushing has an inner circumference and several deformation projections located on the inner circumference.

6. The fastening device according to claim 4, wherein the bushing has an outer periphery and conical rings arranged on the outer periphery at opposed ends of the bushing, wherein the conical rings have a slant ascending in a direction toward end faces of the opposed ends, respectively.

7. The fastening device according to claim 3, wherein the insertion opening in the fitting part tapers in a direction toward one of the openings formed as a bore and receiving the securing bolt, wherein the insertion opening emerges from the fitting part in a direction away from the bore.

8. The fastening device according to claim 1, wherein the pin is a clamping pin and has a clamping pin section with an elliptical cross-section whose greatest axis extends transversely to the longitudinal direction of the insertion opening when the fitting part is in the fastening position.

9. The fastening device according to claim 8, wherein the clamping pin section has a non-round cross-section and a hard-elastic bushing placed onto the non-round cross-section and surrounding the non-round cross-section, wherein the non-round cross-section secures the bushing against rotation.
